(19) United States
(12) Patent Application Publication
(10) Pub. No.: US 2013/0282351 A1
(43) Pub. Date: Oct. 24, 2013

(54) METHOD AND TOOTH RESTORATION DETERMINATION SYSTEM FOR DETERMINING TOOTH RESTORATIONS

(71) Applicant: Martin Tank, Heidelberg (DE)

(72) Inventor: Martin Tank, Heidelberg (DE)

(73) Assignee: STRAUMANN HOLDING AG, Basel (CH)

(21) Appl. No.: 13/978,106

(22) PCT Filed: Dec. 12, 2011
(86) PCT No.: PCT/EP2011/006257

§ 371 Date: Jul. 2, 2013

(30) Foreign Application Priority Data
Jan. 7, 2011 (DE) 10 2011 008 074.0

(51) Int. Cl. G06F 17/50

(52) U.S. Cl. CPC G06F 17/5009
USPC 703/11

(57) ABSTRACT

The invention describes a method of determining virtual tooth restorations on the basis of scan data (D) of oral structures, wherein a model database (DB) comprising a number of parameterized tooth models for each of several tooth types is used, whereby the parameterization is carried out on the basis of model parameters comprising position parameters and/or shape parameters and whereby each tooth model (M) is linked with a number of tooth models (M) of the same tooth type, and wherein, for each desired tooth type, an optimal tooth model (M) in the model database (DB) is determined by means of an iterative method in which initially at least one start tooth model (M) of the desired tooth type is selected from the model database (DB), and subsequently, commencing with this start tooth model (M), in each iteration step (S) a tooth model (M) is tested with regard to a quality value, wherein for individualization, the tooth model (M) currently in test is adjusted to the scan data (D) by varying model parameters and a quality value is computed for this individualization. Furthermore, at least one tooth model (M) linked with the tooth model (M) in test is also, for individualization, adjusted to the scan data (D) by variation of model parameters and a further quality value is computed for this individualization. On the basis of the computed quality values, a new tooth model (M) in test of the desired tooth type is selected if necessary from the model database (DB) for the next iteration step (S). Iteration is interrupted upon reaching a quality criterion, and finally at least one virtual tooth restoration is determined from among the optimal tooth models (M) and scan data (D). The invention also describes a method of generating a model database (DB) for use in such a method, a method of manufacturing or selecting a tooth restoration part, and a tooth restoration determination system (5) for determining virtual tooth restorations.

The invention describes a method of determining virtual tooth restorations, on the basis of scan data of oral structures, for use in dental CAD/CAM systems. Such methods are already firmly established in dentistry, dental technology and orthodontistry, and descriptions of such systems can be found in the exemplary documents U.S. Pat. No. 5,217,375A, U.S. Pat. No. 7,708,560 B2, U.S. Pat. No. 7,581,953 B2, EP 06 34 150 A1, EP 09 13 130 A2, DE 10 2005 033 738 A1 and WO 0239056 A1. In the context of the present invention, oral structures are to be understood to mean teeth with neighboring anatomical structures such as gum, jawbone, nerve tracts etc., as well as artificial structures such as implants, abutments, other anchoring systems, static and dynamic bite registrations, etc. Furthermore, the invention describes a method for the creation of a model database for use in such a method, as well as a tooth restoration determination system for determining virtual tooth restorations. The invention further describes a method for manufacture or selection of a tooth restoration part.

In the field of digital dental technology, scan data of oral structures are generally determined optically or radiologically. Optical scanners for three-dimensional measurement directly from intra-oral surface structures, or from extra-oral impressions of oral surface structures, are widespread and economical. Usually, one obtains triangulated surface data, which in the case of open systems can be saved in STL format. Radiological scanners such as digital volume tomographs (DVT) or computer tomographs (CT) use X-rays to generate volume datasets of oral structures. Surface structures can also be extracted from these volume datasets by applying thresholding methods in which the intensity values (measured in Hounsfield units) of the individual scan elements are analyzed to determine whether they exceed a certain threshold. Radiologically dense structures such as teeth can be selected in this way and used as triangulated surface data. Computations with MR scan data are more complex, in which contour analysis methods are preferably applied, which work on the basis of the gradients of adjacent scan elements. With the analysis methods described above, triangulated surface data of desired boundary surfaces in the scan data can be obtained for all modalities (imaging devices). In the context of the present invention, the scan data can, for example, comprise all of the above mentioned types of data, regardless of how they have been obtained, but also other algorithmic and/or interactively determined structures such as preparation lines, segmentation lines and anatomical landmarks as well as desired contact points for the virtual tooth restorations, etc.

On account of the necessary high level of precision, optical scan data are usually used for the evaluation or computation of virtual tooth restorations. In the context of the present invention, the term tooth restoration parts includes every type of object that can be made for the treatment of dental defects. Examples are inlays, onlays, partial crowns, crowns, telescopic crowns, bridges, veneers, implant abutments, partial prostheses and prostheses. It shall be emphasized once again that, in the context of the present invention, for the sake of simplicity, tooth replacement parts are also covered by the term tooth restoration parts. The term virtual tooth restoration (referred to more briefly as tooth restoration in the following) is to be understood to include appropriate electronic representations of tooth restorations, i.e. digital three-dimensional representations of such tooth restoration parts. For example, to manufacture a tooth restoration part, a CAD/CAM data set of the corresponding virtual tooth restoration can be forwarded to a manufacturing machine.

When treating a dental defect, a preparation of the teeth usually takes place, i.e. caries, old filling material or defective tooth parts are removed. What remains for each tooth is the remaining tooth structure, whose surface is divided into a prepared part (cavity) and an unprepared part. The boundary line between unprepared tooth surface and prepared tooth surface is referred to as the preparation line. In addition to the preparation lines, present only in the case of prepared teeth, each tooth also has at least one segmentation line that separates a tooth from extra-dental structures such as gum and/or bone and/or adjacent teeth. It follows from these definitions that segmentation lines and/or preparation lines delimit unprepared tooth surfaces. In the scope of the invention, these boundary lines can be interactively drawn in the scan data, whereby algorithmic assistance, based on the analysis of surface curvatures of the scan data, is usually used in their determination.

Because of the complex structure of the scan data and the multitude of functional-aesthetic criteria that must be fulfilled (adjustment to opposing dentition possibly under consideration of jaw movement, adjustment to adjacent teeth under consideration of contact points, adjustment to the preparation lines in order to obtain an optimal margin fit, compliance with minimum material strengths in order to obtain a satisfactory mechanical stability, consideration of desired tooth shapes in the anterior tooth region, etc.), an interactive computer-aided creation of tooth restorations using a graphical user interface is often difficult to perform and is very time-consuming. Use of model-based processes can constitute an improvement, in which prior morphological knowledge about the anatomical variations of natural tooth shapes is used in the computation of tooth restorations, and in which the functional-aesthetic criteria are considered in the form of optimization criteria in the adjustment of the tooth models to the scan data.

Because of the economic relevance of prosthetic dental treatment, several model-based methods exist for the determination or computation of tooth restorations. In the case of computer-aided CAD/CAM methods, the basic approach is similar for all methods. First, three-dimensional digital tooth models are adjusted to the scan data, and this step is generally referred to as the individualization of tooth models. Subsequently, a computation of the tooth restorations takes place on the basis of the individualized tooth models and scan data. Finally, the appropriate tooth restoration parts are machined according to the tooth restorations.

DE 102 52 298 B3 describes a method in which the model database used is based on a main components analysis of a large quantity of proband dental scans. Here, parameterization of the tooth models comprises the linear factors of the most significant main components. A description of a specific search strategy for the use of geometrically non-deformable tooth models is not given in this document. Furthermore, the individualization of tooth models is performed for a single tooth type and not for groups of linked tooth models of different tooth types. In that document, the tooth type is generally a tooth number, but can also describe sets of tooth models according to other criteria (age, morphological properties, etc.). In the case that the tooth models of a tooth number differentiate into several tooth types, that document does not describe any effective search strategy for automatically determining the tooth type to be used. In particular, when tooth types that are defined according to morphological criteria are used, it is left open as to what automated algorithm is used to assign tooth models to the tooth types.

US 2006/0183082 suggests another method for the computation of tooth restorations, in which the tooth models of a model database can be sorted according to type, age, gender and/or ethnicity, and each tooth model has a specific closed border line at the edge of the occlusal surface. A description of how to automatically and effectively determine optimal tooth models from such a model database for the determination of tooth restorations is not disclosed in that document. Also, the model database described does not contain any information about allowable geometric deformations of the tooth models. The focus of that document lies rather in the construction of tooth restorations after successful individualization. To this end, border lines of individualized tooth models are connected to the corresponding preparation lines of the scan data according to specific geometrical rules, in order to construct the missing side surfaces of the tooth restorations.

The patent documents DE 20 2007 014 550 U1, DE 20 2005 020 715 U1, DE 10 2006 043 284 A1, DE 10 2004 038 136 A1, DE 196 42 247 C1, DE 199 23 978 A1, DE 198 38 239 A1, EP 06 43 948 A1, US 2009/0148816 A1 and U.S. Pat. No. 7,433,810 B2 disclose computation methods which, for many reasons, yield unnatural shapes for tooth restorations and/or for which the determined tooth restorations can comprise functional-aesthetic shortcomings. This may be on account of a lack of automation of the methods, since considerable user interaction takes place in the optimization of the tooth models. In particular, interactively controlled large-scale geometrical deformations of tooth models (positioning of anatomical landmarks, creation of desired contact points, etc.) are to be regarded critically, since these are to a great extent subjective and are not reproducible.

It is an object of the present invention to provide a model-based method and tooth restoration determination system for the straightforward and reliable determination of virtual tooth restorations of desired tooth types that meet functional-aesthetic criteria, which determination can be satisfactorily performed quickly and with a low level of user interaction. The method should thereby be able to use geometrically deformable tooth models as well as geometrically non-deformable tooth models.

The object is achieved by a method according to claim 1, and by a tooth restoration determination system according to claim 15.

In the context of the present invention, the fundamental terms tooth type and tooth model are to be understood in a very general manner. A tooth type is to be understood in the context of the invention as a very general possible grouping of teeth. For example a grouping can be done according to tooth number and/or age and/or abrasion and/or ethnicity and/or gender and/or according to morphological features (number of roots, number of cusps, etc.). The grouping can also be done according to whether a tooth belongs to the incisors, canines, pre-molars, molars, to the maxilla or the mandible. It is also possible to group teeth with different tooth numbers to a complex tooth type. It shall be emphasized here that, in practice, a grouping according to tooth number is preferred, i.e. tooth type and tooth number can be used synonymously. Similarly, the term tooth model is used in a very general manner. A tooth model can comprise several model parts that describe, for example, anatomical structures such as tooth surfaces, gum, jaw bone, nerve structures etc., as well as artificial structures such as implants, abutments, other anchoring systems, etc. Furthermore, a tooth model can also comprise preparation lines, segmentation lines, anatomical landmarks, tooth axes, directional terms, surface regions and other characteristic geometric structures. It is important that at least those parts of the teeth are modeled that are required for determining virtual tooth restorations. The remaining model parts preferably serve principally to stabilize the individualization procedure, since these can be adjusted to the corresponding structures in the scan data.

To determine virtual tooth restorations, according to the invention, parameterized tooth models are used from a specifically structured model database that contains a number of tooth models for each tooth type. In the following, the set of all tooth models of a tooth type is referred to as a model class, whereby the tooth models of a model class can differ in their spatial resolution and their topological construction (e.g. different triangulation, different model parts, different anatomical landmarks, etc.). Parameterization is performed on the basis of model parameters that comprise position parameters and/or shape parameters. The six position parameters of a tooth model describe the spatial position and orientation of a tooth model in the scan data. Anatomically meaningful shape variations of each tooth model can be created optionally by parameterized geometrical transformations that can differ from tooth model to tooth model and that are stored in the model database. In other words, the number of shape parameters can vary from tooth model to tooth model. Furthermore, besides position and/or shape parameters, the model parameters can comprise further parameters that parameterize, for example, regions and/or boundary lines on the surfaces of the tooth models and/or material properties.

According to the invention, an optimal tooth model with a maximum quality value of the individualization is determined for each desired tooth type from a model database. Individualization is to be understood as the adjustment of tooth models to scan data, whereby optimization criteria, such as the adjustment of tooth models to the teeth and/or remaining tooth structure should be complied with as far as possible. The quality value of an individualization quantitatively describes how well the optimization criteria were fulfilled.

According to the invention, determination of an optimal tooth model from the model database is performed using an iterative method. First, at least one start tooth model of a desired tooth type is selected from the model database and then, commencing with this start tooth model, a tooth model is tested at each iteration step with regard to a quality value. To this end, the tooth model currently in test is individualized by varying model parameters, and a quality value is computed for the individualization. Subsequently or in parallel, at least one tooth model linked to the tooth model in test is also individualized and a quality value is computed. On the basis of the computed quality values, a selection may take place of a new tooth model in test for the desired tooth type for the next iteration step, for example a comparison of the quality values may indicate that another tooth model is better suited than the tooth model currently in test (or in the first iteration step of the start tooth model). The fulfillment of a quality criterion determines whether the iteration should be interrupted, for example at the end of an iteration step.

Finally, at least one tooth restoration is determined from the optimal tooth models and the scan data. The appropriate methods will be known to the skilled person. Basically, the preparation lines are merged with the corresponding tooth models as smoothly and continuously as possible, and the cavities of the prepared teeth are then added as lower boundaries. The result for the tooth restorations is three-dimensional models of milling objects that can be manufactured by machining. The tooth restorations can also be formed in several parts, by determining a supporting structure first and then an upper structure with the occlusal surfaces. Particularly for prosthesis manufacture, the creation of a negative form of the determined tooth restoration is advantageous. With the aid of this, the tooth restoration parts can be set up three-dimensionally during the prosthesis manufacture.

The method according to the invention allows the use of tooth models with a reasonable computation effort and in as automated a manner as possible. In particular, owing to the particularly effective iterative search strategy using interlinked tooth models of a tooth type to determine optimal tooth models, the method can also be used with geometrically non-deformable tooth models. This is especially helpful when a limited number of cheap pre-fabricated artificial teeth (prosthetic teeth, dental blanks, etc.) are to be used for prosthetic dental treatment. An example for this approach is the manufacture of full dentures. In the corresponding computer-aided computation process, the tooth models that match the dentures should not be subject to any geometrical deformations. The number of available tooth models can be significant, so that in this case effective search criteria are particularly important for the identification of optimal tooth models for determining tooth restorations. Such prosthetic dental treatment is of interest insofar as manufacture of individual tooth restorations is associated with considerable expense.

The independent claims and the following description contain particularly advantageous embodiments and further developments of the invention, whereby in particular the analysis system according to the invention can be adapted analogously to the features of the independent method claims. Furthermore, the various features of different embodiments can be combined in the context of the invention to give other embodiments.

According to a further preferred embodiment of the method according to the invention, for each desired tooth type of a tooth type group, a start tooth model is first selected from the model database and then, commencing with these start tooth models, a group of tooth models is tested with regard to a quality value (group quality value) at each iteration step. To this end, the tooth model group currently in test is individualized by varying model parameters, and a quality value is computed for the individualization. Subsequently or in parallel, at least one tooth model group (corresponding to the tooth type group) is also individualized and a further quality value is computed. This further group results from varying the current group in test by replacing at least one tooth model of the current group in test by a tooth model to which it is linked. On the basis of the computed quality values, a selection may take place of a new tooth model group in test for the desired group of tooth types. Here also, the fulfillment of a quality criterion determines whether the iteration should be interrupted, for example at the end of an iteration step. Therefore, besides adjusting individual tooth models to the scan data, this method makes it possible to adjust groups of tooth models to the scan data, which is advantageous particularly in the case of crown and bridge constructions.

Preferably, the individualization of tooth models is done by defining and solving an optimization problem. To solve the optimization problem, model parameters are varied until the optimization value is minimized, or an abort criterion is satisfied. The optimization value of the optimization problem may particularly preferably thereby comprise a number of optimization partial values that each correspond to certain desired optimization criteria.

Preferred optimization partial values describe the adjustment of the tooth models to the teeth and/or to remaining tooth structure, i.e. the modeled tooth surfaces of the tooth models should be aligned as far as possible to the corresponding unprepared tooth surfaces of the scan data. Further preferred optimization partial values describe the adjustment of the tooth models to the opposing dentition and/or to static bite registrations and/or to dynamic bite registrations, whereby an adjustment of the tooth models to desired contact points and contact surfaces is possible. When computing these optimization partial values, jaw motion may also optionally be considered. A further optimization partial value describes the adjustment of the tooth models to the adjacent teeth, whereby an optimal interdental space should preferably be formed in addition to the adjustment to desired contact points and contact surfaces. A space is sought in which food particles will not lodge, and which at the same time allows satisfactory cleaning of the teeth. Insofar as preparation lines and/or segmentation lines and/or anatomical landmarks are present in the scan data, optimization partial values can also be computed for the tooth models that describe the adjustment of the tooth models to the preparation lines and/or segmentation lines and/or anatomical landmarks. A further optimization criterion concerns the mechanical stability of the tooth restorations that result from the tooth models and the scan data. The corresponding optimization partial value preferably describes the compliance with minimum material strengths in order to ensure the mechanical stability of the tooth restorations. In addition to these exemplary functional optimization criteria, aesthetic optimization criteria may also be considered, which are especially important for tooth restorations in the anterior tooth region. The patient may prefer a particular shape (rectangular, triangular, square, shovel-shaped etc.) for the upper incisors. The relevant optimization partial value can describe the discrepancy between the tooth model and the desired shape.

The target structures (teeth, remaining tooth structure, opposing dentition, bite registrations, adjacent teeth, preparation lines, segmentation lines, anatomical landmarks, etc.) required for the individualization of tooth models can be determined algorithmically or interactively in the scan data. Suitable methods are known to the skilled person, whereby automated methods are particularly advantageously, since these allow an objective and quick approach.

As described above, groups of tooth models can also be individualized, whereby tooth models within a group are preferably linked. In this way, a further optimization partial value can belong to every linkage group.

The range of a linkage group can be determined basically by any set of different tooth types from the set of desired tooth types (e.g. tooth types 13 to 18, or tooth types 15 and 26), i.e. the corresponding tooth models do not necessarily have to be adjacent. If the tooth models are adjacent, the adjacent tooth models are preferably linked in such a way that the corresponding optimization partial value describes the contact situation of the adjacent tooth models. Furthermore, within a linkage group, the positions and/or shapes of the individual tooth models can be linked in such a way that anatomically reasonable relationships between the tooth models are fulfilled. To this end, linking parameters of the linkage group can define relationships for the position and/or shape parameters of the individual tooth models. The optimization partial value for the relative positions of tooth models preferably results from the spatial relationships of anatomical landmarks of the tooth models. The linking parameters can describe desired relationships of the landmarks relative to each other, and the optimization partial value for the position relationships can be computed from deviations from these relationships. The orientation of tooth model incisor edges is given as an example. Although the shapes of the tooth models can vary greatly here (rectangular, triangular, etc.), the requirement that the landmarks of the tooth model incisal edges must lie on a parameterized curve results in a good alignment of the tooth model incisal edges in the incisor region. It is similar in the case of optimization partial values that describe the spatial relationships of the shapes of tooth models. Preferably, a model database is built using proband jaw scans wherein the tooth models created from one jaw scan correspond to each other since they all originate from one proband. The optimization partial value for the linking of the shapes of tooth models can describe the deviations from the correlations within a linkage group.

Preferably, the range of at least one linkage group should correspond to the range of the scanned teeth, so that as much tooth and remaining tooth structure as possible is analyzed by the method. Particularly in the case of existing tooth preparations, the shapes of the tooth restorations are deduced from the tooth structure and remaining tooth structure of all of the scanned teeth. The greater the dental defect for a tooth type, the more important is the analysis of the tooth structure and remaining tooth structure of the other tooth types. However, particularly in the case of only a minor defect, for example in the case of an inlay preparation without cusps, the method according to the invention functions excellently with only a single tooth type. Alternatively, when several tooth types are used, the linking optimization partial values of tooth types with minor dental defects can be weighted only very slightly, or can even be weighted with zero.

The individual optimization partial values are ultimately combined to a single optimization value for the individualization. This is preferably done by computing a weighted sum of the optimization partial values. In this way, the weighting factors allow a control of the influence of each of the individualization criteria. In this way, one optimization value is obtained according to the invention for a set of model parameters. To individualize a tooth model, model parameters are varied until the optimization value is minimized, or an abort criterion is met. The quality value of the individualization is preferably determined from the minimum optimization value.

In a preferred embodiment of the invention, after determining the optimal tooth model and before determining the tooth restorations, a precision adjustment of the optimal tooth models relative to each other and/or to the scan data is performed. This is advantageous, since the shape variety is effectively limited by the number of tooth models in the model database and the number of shape parameters, and the computed tooth restorations should be as precise as possible. It is advantageous to apply locally bounded deformation transformations that perform a precision adjustment of the contact situation among the tooth models as well as a precision adjustment to the teeth, remaining tooth structure, adjacent teeth, opposing dentition, bite registrations, preparation lines, segmentation lines, anatomical landmarks, contact points etc., using displacement values that are as small as possible and that do not generate any edges or folds.

According to the invention, the search for the optimal tooth model of a tooth type can commence at one or more start tooth models. In the case of several start tooth models, a temporary optimal tooth model with a quality value for the individualization is obtained by the method for each single start tooth model. The final optimal tooth model, then, is the temporary optimal tooth model that has the best quality value.

Particularly when a single start tooth model is used, the start tooth model can be specified in the model database, whereby this start tooth model should preferably be the mean tooth model of a tooth type.

Equally, the start tooth model can be determined from a geometrical analysis of the scan data. To this end, geometric dimensions can be determined for teeth and/or remaining tooth structure present in the scan data, and using these, a start tooth model with geometric dimensions that are as similar as possible can be identified in a model database.

The selection of several start tooth models for a tooth type can be carried out analogously to the selection of a single start tooth model. It is easiest to establish the start tooth models in the model database that is used by the method, whereby it is also advantageous if the start tooth models are mean tooth models of sub-groups of the tooth models of a tooth type. To this end, the sub-groups should comprise morphologically similar tooth models of the tooth type. If the start tooth models are to be determined by a geometrical analysis of the scan data, a number of start tooth models is selected from the model database, whose geometric dimensions correspond as closely as possible to the geometric dimensions of the teeth and/or remaining tooth structure in the scan data.

A further preferred variant of the method according to the invention is characterized in that the tooth types present in a model database are forwarded for selection to a selection unit, and the desired tooth types are selected with the aid of a selection signal, for example by using a graphical user interface. This selection can be clearly shown using a graphic dental notation system.

In addition or alternatively, in order to be able to influence which tooth models of a model database are to be used in the method according to the invention, the tooth models of a desired tooth type present in the model database are preferably forwarded for selection to a selection unit, and desired tooth models are selected with the aid of a selection signal, and the optimal tooth model is determined from these. For example, the structure of the linking of the tooth models of a model database and/or a linear sorting of tooth models of a model database are particularly preferably forwarded for selection to a selection unit, and tooth models are selected with the aid of a selection signal. This approach is particularly advantageous in the selection of tooth models of specific shapes in the incisor region, or in the selection of tooth models for dental prosthesis manufacture.

In a preferred variant of the method according to the invention, the tooth models of a model database are present in various resolutions. It is then advantageous to start the method with the tooth models having the lowest resolution level, whereby, after a successful run, the resolution level is increased in later stages. This primarily increases the speed of the method. The database can, for example, also comprise complete sets of tooth models in various levels of resolution, or partial databases with different resolution levels and, after a complete optimization, i.e. after the selection of an optimal tooth model from a database or partial database with a low resolution level, the method is then carried out again with a database or partial database with a higher resolution. The optimal tooth model from a previous run can be used as a start model for the following run. Equally, it is possible to work at various levels of resolution in each iteration step when solving the optimization problem.

The geometrically deformable tooth models of a model database can be constructed according to various principles. Since target structures in the scan data are basically boundary surfaces, surface models are expedient for use as tooth models. The geometric modeling of the model surfaces can be performed by simple triangulation, or by using mode complex higher-order modeling techniques (Bezier models, non-uniform rational B-spline models, B-spline models, etc.). Compared to surface models, the use of volume models (voxel models, finite-element models, etc.) involves more computation effort and storage. These allow a good modeling of interior structures of teeth as well as mechanical properties. It is advantageous to label anatomical landmarks, tooth axes, direction terms, surface regions and/or other characteristic geometric structures on the tooth models, since these labels can be transferred to the scan data after successful individualization of the tooth models.

The geometric transformations of tooth model are described by shape parameters, whereby this parameterization can be realized in various ways. Preferably, transformations are used in which the shape parameters of the tooth models are sorted according to their influence on the tooth model geometry. In other words, the important shape parameters are at the top of the shape parameter list, and will be optimized first during tooth model individualization, before optimizing shape parameters that parameterize tooth model details. In this way, an increase in speed and stabilization of the tooth model individualization is achieved. The domain of definition of the shape parameters is preferably not arbitrary, but is preferably determined by the analysis of training data. In this way, it can be achieved that only anatomically reasonable tooth models are generated by the shape parameters.

The use of parameterized three-dimensional transformation fields for the tooth models is particularly advantageous for the method proposed according to the invention. A three-dimensional transformation field comprises displacement vectors for the vertices (support points) of a tooth model. These displacement vectors can also be parameterized, for example by a parameterized displacement of anatomical landmarks of a tooth model. The displacement vectors of all vertices are then obtained, for example, from the distances of the vertices to the displaced anatomical landmarks. In addition to the morphing of tooth models, this permits a reduction of the storage capacity of the model database, since tooth models that are obtained to a satisfactory level of precision from another tooth model under application of a parameterized three-dimensional transformation can be removed from the model database. On the other hand, when applying the method according to the invention when a quick result is more important than precision, it is advantageous to use shape parameters that correspond to geometrical construction parameters (e.g. tooth width, tooth depth, cusp distance, incisal edge thickness, root length, etc.).

The method proposed according to the invention can also, as explained above, be used in particular with geometrically non-deformable tooth models. This is expedient when the tooth models correspond to previously manufactured artificial teeth, tooth groups or dentures that can be manufactured economically and in large quantities before carrying out the method. One example is prosthesis manufacture on the basis of a library of predefined denture teeth.

In a method according to the invention of generating a model database, which contains a number of parameterized tooth models (i.e. at least one tooth model) for each of several tooth types, for use in the method described above, the parameterization is carried out by applying model parameters that comprise position parameters and/or shape parameters. Furthermore, each tooth model is linked with a number of tooth models of the same tooth type. Such a model database for the method according to the invention can be created in various ways. Automated methods for building a model database are advantageous since, particularly in the case of a large number of tooth models for a tooth type, the interactive creation of a linking and the geometric transformation of the tooth models can be subjective and very slow.

According to a preferred method, the entire model database or at least parts of the model database are constructed by analyzing a set of scan data of artificial and/or natural oral structures. In the context of the invention, artificial oral structures are to be understood as artificial teeth or groups of teeth, dentures and also implants, abutments and other anchoring systems. Usually, such artificial oral structures are available in a multitude of ready-to-use versions from various commercial suppliers. On the other hand, in the context of the invention, natural oral structures comprise natural teeth or groups of teeth, dentition and also gum, jawbone, nerves and other anatomical structures. Preferably, the optical scan data of natural oral structures are obtained from optical scans of plaster casts of caries-free and defect-free upper and lower jaws. Of course, radiological scan data of jaws can also be used, whereby such scan data are less precise than optical scan data, but include subgingival and intradental structures.

Usually, the scan data must first be segmented in order to obtain scan data of a desired tooth type in a first database building step, especially in the case of scan data of natural oral structures. This step is usually dispensed with in the case of scan data of artificial oral structures, since these are usually provided in a physically separated manner and can be scanned individually. In both cases, the result of the measurement of physically existing oral structures is a scan data set for a desired tooth type, which can be used in building a model database.

In the subsequent step of the method according to the invention, the tooth models of a tooth type are constructed, i.e. an adjustment of surface tooth models or volume tooth models (of a desired resolution) to the scan data of a desired tooth type takes place. Optionally, anatomical landmarks, tooth axes, directional terms, surface regions and/or other characteristic geometric structures can be determined for the tooth models.

According to the invention, a linking of the tooth models of a model class can be effected particularly preferably by forming clusters of morphologically similar tooth models, whereby the tooth models of a cluster are interlinked, as are the clusters themselves.

To determine clusters with corresponding mean tooth models, an analysis of morphological deviations among the tooth models can have been carried out previously, by computing a difference value for each possible pair of tooth models. This can be achieved by aligning the tooth models of a pair as far as possible by determining optimal translation and rotation values, and the difference value describes the remaining morphological difference between the tooth models.

Tooth models are preferably regarded as morphologically similar and then interlinked when the relevant difference values lie below a threshold. In other words, the set of all tooth models is split into clusters according to the defined threshold. The smaller the chosen threshold, the greater the number of clusters, whereby at this stage, the clusters are by definition not yet interlinked.

An interlinking of the clusters can take place preferably on the basis of the mean tooth models of the clusters. On the basis of the difference analysis among the tooth models, (n−1) difference values are obtained for each of n tooth models of a cluster. Preferably, the tooth model whose sum of squares of the difference values is smallest is regarded as the cluster mean tooth model. After determining the mean tooth model, the clusters are appropriately linked so that a coherent linking of all tooth models of the model class can be built. The mean tooth model of the largest cluster is thereby preferably linked to all other mean tooth models of the other clusters. Another linking, of cluster mean tooth models that are morphologically similar, can also be added. In the case of a large number of tooth models, an iterative application of this method is expedient. Clusters that exceed a certain size can be split into second-order clusters, and the corresponding tooth models can be linked accordingly.

Particularly when scan data of natural oral structures are used to build at least part of a model database, in a subsequent process step geometric transformations are preferably added to the tooth models in order to also create intermediate shapes of tooth models for individualization. Suitable geometric transformations for a tooth model are preferably defined by the requirement that the shape of the tooth model can be smoothly converted into a tooth model to which it is linked. The shape parameters are thereby preferably ordered according to their influence on the tooth model geometry. This ensures that a morphing only takes place between morphologically similar tooth models, and that the corresponding shape parameters can be effectively varied.

To carry out the method, a tooth restoration determination system according to the invention requires an interface for receiving scan data measured by a modality; a selection unit for selecting the tooth types to be used by the method; a memory module with a model database that comprises a number of parameterized tooth models for each of various tooth types, whereby the parameterization is performed using model parameters comprising position and/or shape parameters, and whereby each tooth model is linked with a number of tooth models of the same tooth type. The tooth restoration determination system also requires an optimization unit realized to determine an optimal tooth model for each tooth type from the model database in an iterative method in which, commencing with a start tooth model, a tooth model is tested with regard to a quality value at each iteration step. To this end, the optimization unit comprises a loading unit, an individualization unit and a quality determination unit. With the aid of the loading unit, tooth models are loaded from a model database and forwarded to the individualization unit, which is realized to adjust a tooth model currently in test and at least one further tooth model that is linked to the tooth model in test to the scan data by varying model parameters. In the quality determination unit, quality values are determined for the individualization of the tooth models, and a quality value for interrupting the iteration is monitored. Finally, the tooth restoration determination system requires a restoration unit in order to determine at least one tooth restoration from the optimal tooth models and the scan data.

The selection, optimization, loading, individualization, quality determination and restoration units of the tooth restoration determination system can particularly preferably be realized in the form of software on a suitable processor of a computer. This computer should comprise an appropriate interface for receiving scan data and a suitable memory module for a model database. The memory module need not be an integral part of the computer, and it is enough for the computer to be able to access a suitable external memory module. A realization of the method according to the invention in the form of software has the advantage that existing tooth restoration determination systems can be upgraded relatively easily by suitable updates. In particular, a tooth restoration determination system according to the invention can also be a control unit for the modality that records the scan data, having the necessary components for the processing of the scan data.

Equally, a method according to the invention for generating at least parts of a model database, separately and prior to the determination of tooth restorations, can be realized in the form of suitable software on a computer. In particular, it is possible to also use the tooth restoration determination system, with which the determination of tooth restorations is performed, for the creation of at least parts of a model database. For example, at certain times when current jobs use the tooth restoration determination system only at a low capacity, free computing capacity can be used to generate tooth models and to store these in the model database for later use.

The method according to the invention and the tooth restoration determination system according to the invention for the determination of tooth restorations can preferably be used in a method according to the invention for the manufacture or selection of a tooth restoration part. To this end, a virtual tooth restoration can first be determined, as described above, on the basis of scan data of oral structures. Subsequently, the tooth restoration part can be manufactured on the basis of the determined virtual tooth restoration. Preferably, this is done automatically using a machine such as a milling unit to which is forwarded a CAD/CAD data set describing the virtual tooth restoration.

Alternatively, a suitable tooth restoration part can be selected from a set of previously manufactured tooth restoration parts, for example by specifying an identification number uniquely assigned to that tooth restoration part.

The invention will be described in the following using the exemplary embodiments and with reference to the drawings:

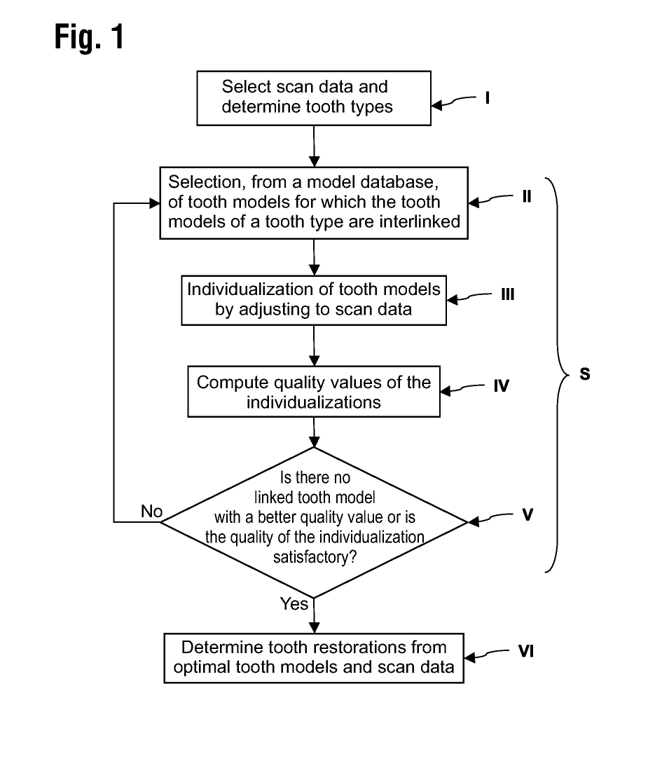

FIG. 1 shows a flow chart representing a possible embodiment of the method according to the invention for determining tooth restorations,

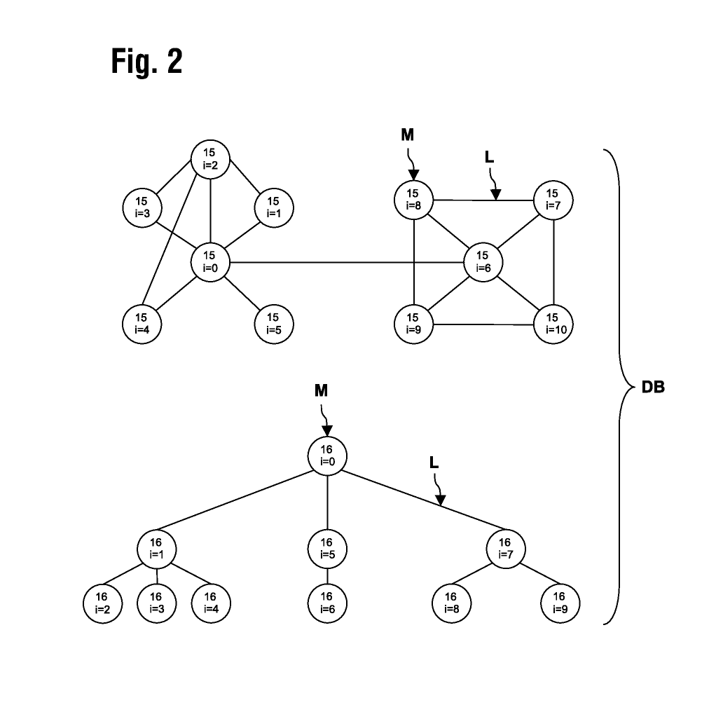

FIG. 2 is a schematic representation of a model database DB with linked tooth models M for two tooth types 15, 16,

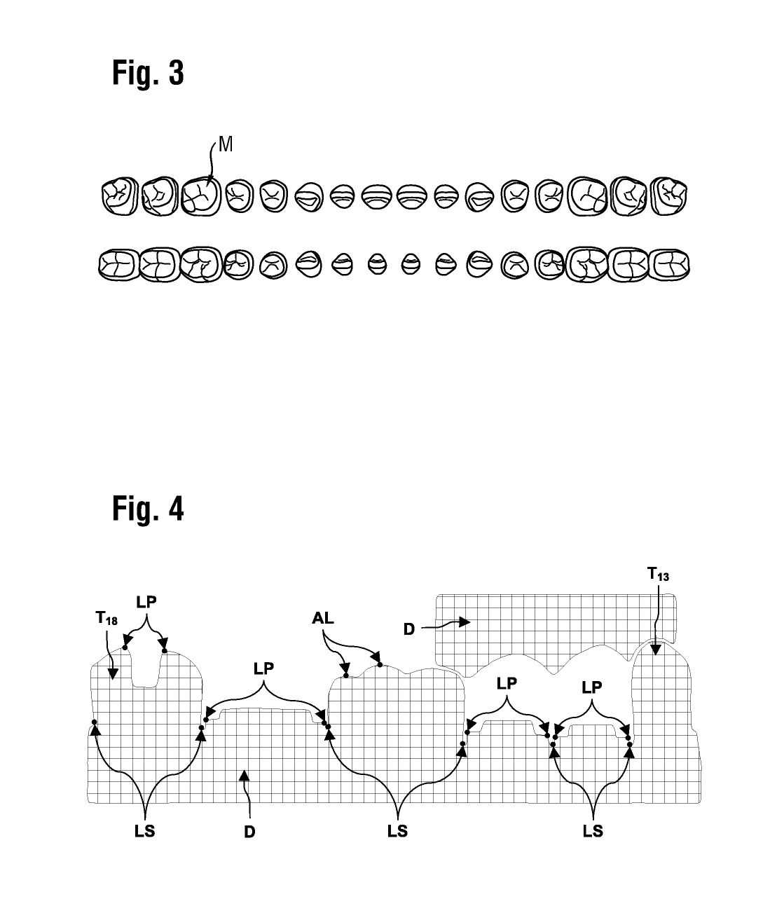

FIG. 3 shows a perspective view of mean tooth models M of a model database for tooth types 18 to 48,

FIG. 4 shows a two-dimensional schematic representation of scan data D of teeth T₁₃ to T₁₈ with antagonist data, marked preparation lines LP, marked segmentation lines LS and marked anatomical landmarks AL,

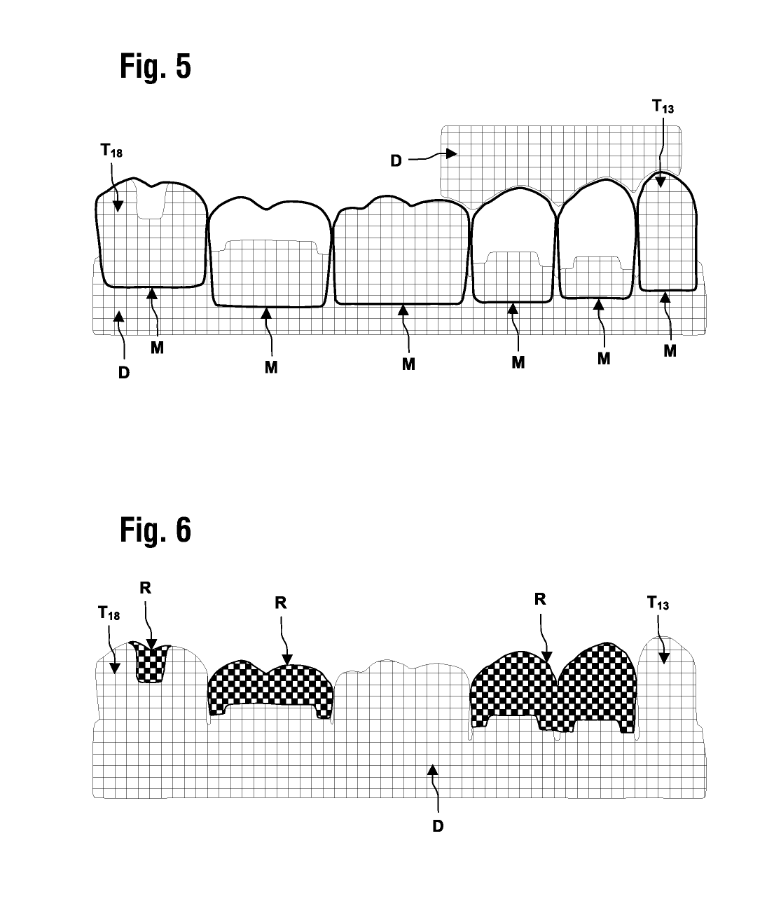

FIG. 5 shows a two-dimensional schematic representation of scan data D of teeth T₁₃ to T₁₈ with optimal tooth models M for an inlay, crown and bridge preparation,

FIG. 6 shows a two-dimensional schematic representation of scan data D of teeth T₁₃ to T₁₈ with tooth restorations R for an inlay, crown and bridge preparation,

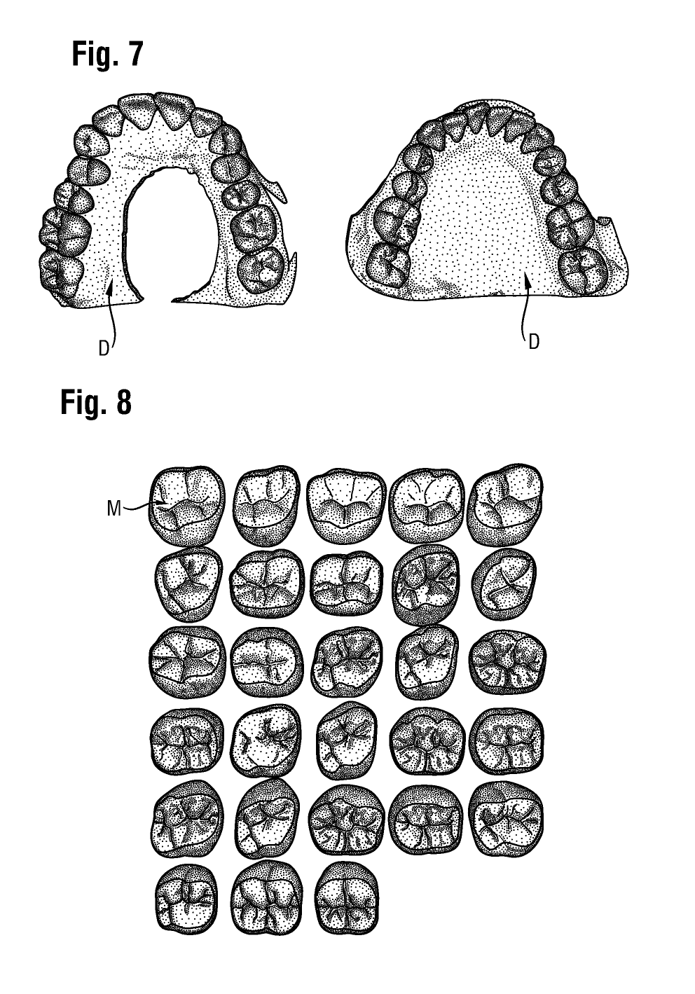

FIG. 7 shows a perspective view of scan data D of a jaw, used for building a model database, showing a maxilla scan on the left-hand side of the diagram, and a mandible scan on the right-hand side of the diagram.

FIG. 8 shows a perspective view of tooth models M of a model class, constructed by adjustment to scan data of a tooth type originating from the segmentation of jaw scans

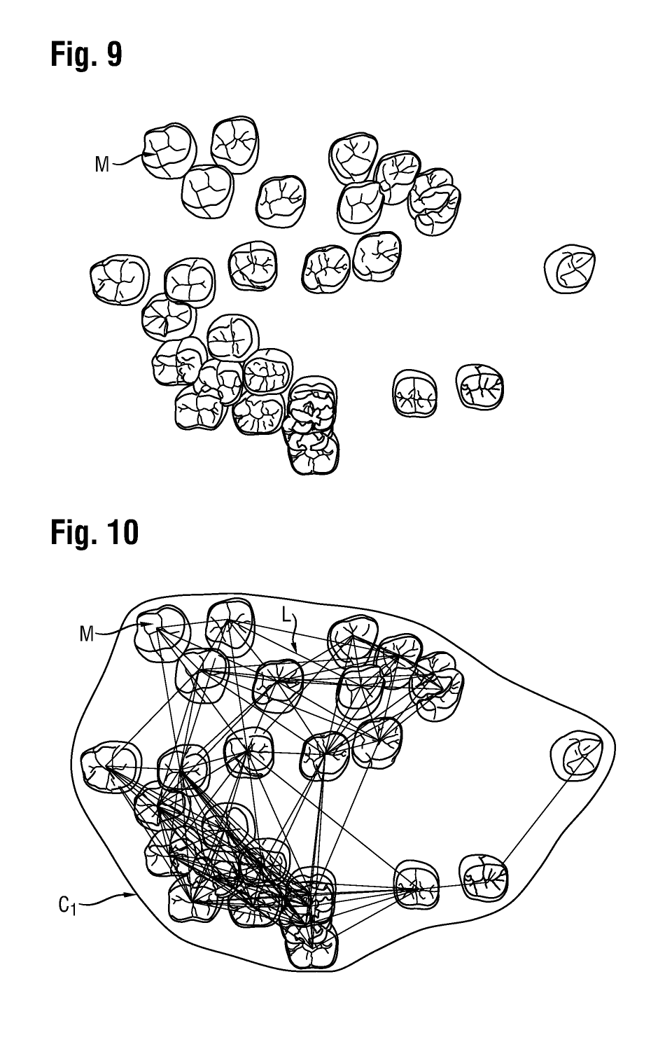

FIG. 9 shows a perspective view of an array of tooth models M of a model class, defined by mutual difference values, whereby morphologically similar tooth models M exhibit a smaller spatial separation to each other in the array.

FIG. 10 shows a perspective view of a possible linking L of tooth models M of a model class with a single cluster C₁,

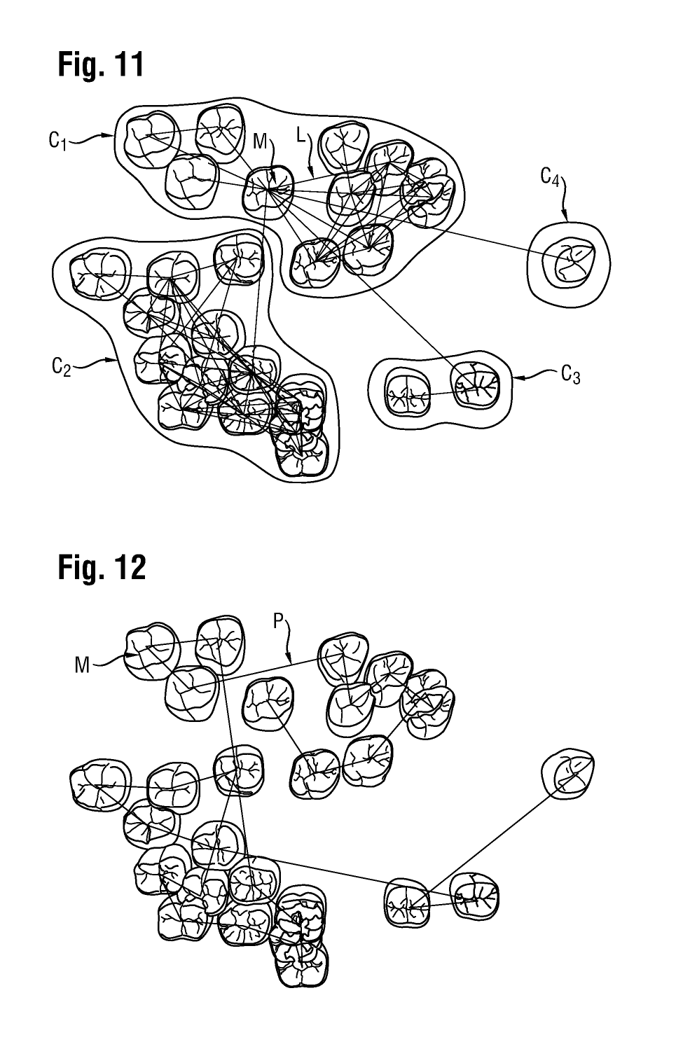

FIG. 11 shows a perspective view of a possible linking L of tooth models M of a model database with four clusters C₁, C₂, C₃, C₄,

FIG. 12 shows a perspective view of a possible linear sorting P of tooth models M of a model class by linking tooth models M with the least morphological differences,

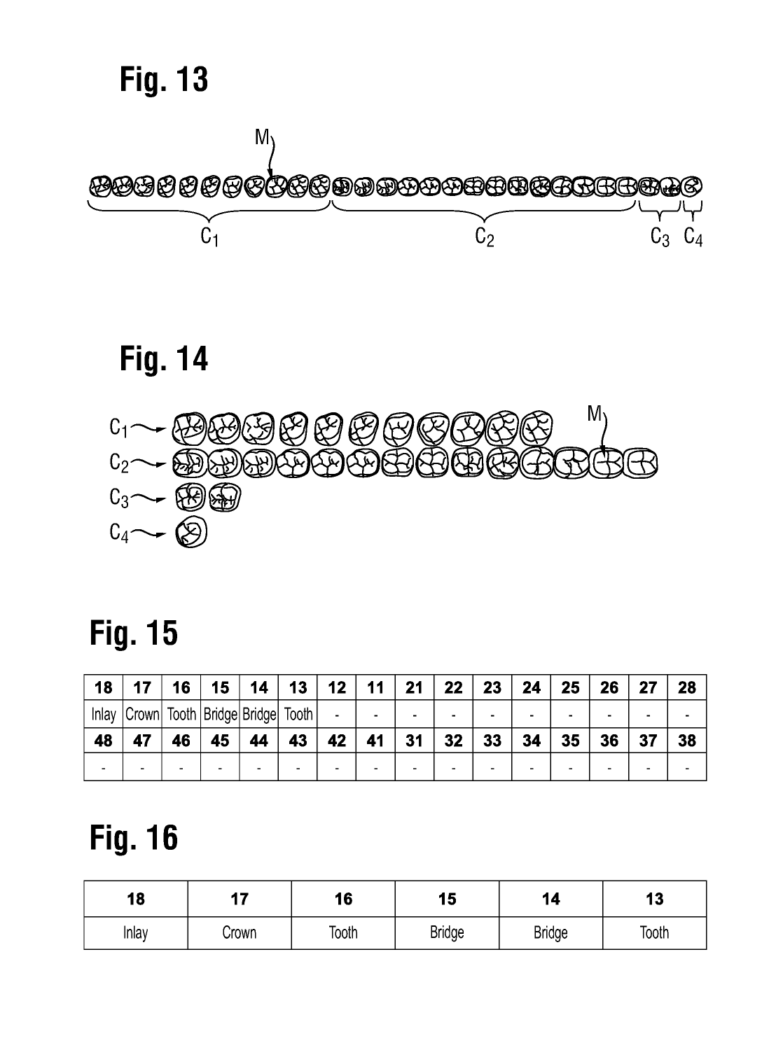

FIG. 13 shows a perspective view of a one-dimensional array of tooth models M of a model class, defined by linear sorting and membership to a cluster C₁, C₂, C₃, C₄ according to FIG. 11,

FIG. 14 shows a perspective view of a two-dimensional array of tooth models M of a model class, defined by linear sorting and membership to a cluster C₁, C₂, C₃, C₄ according to FIG. 11,

FIG. 15 shows a dental notation system with which the tooth types to be used by the method, and optionally also the corresponding preparation types, are defined,

FIG. 16 shows a reduced representation of the dental notation system of FIG. 15,

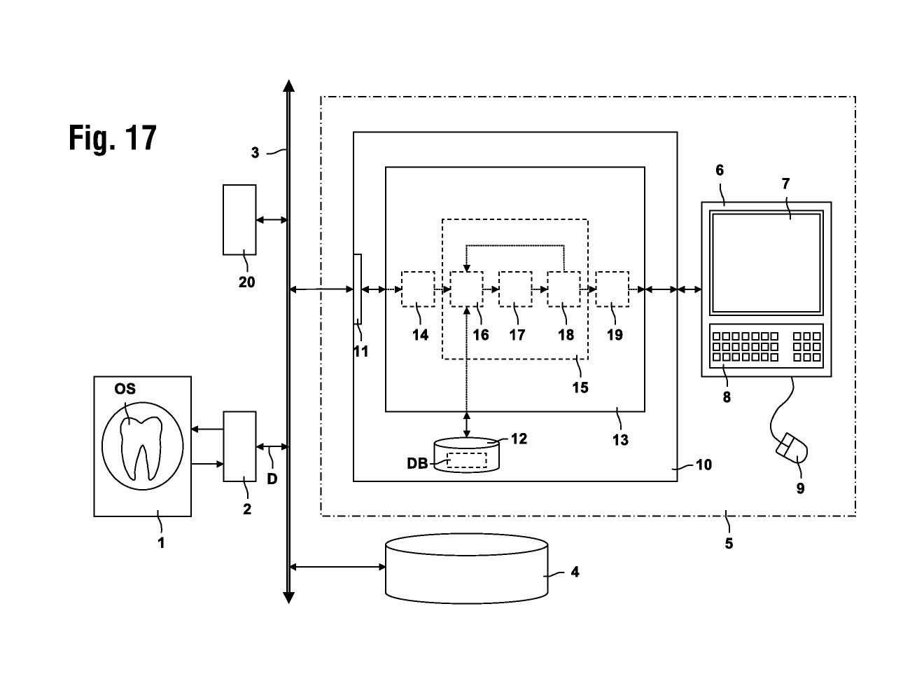

FIG. 17 shows a schematic representation of an embodiment of a tooth restoration determination system according to the invention.

The exemplary embodiment of a tooth restoration determination system 5 according to the invention, schematically shown in FIG. 17 essentially comprises a computer 10 to which is connected a console 6 or similar with a display 7, a keyboard 8 and a pointer device, in this case a mouse 9. The computer 10 can comprise a conventional computer realized in the usual manner, for example a PC or a workstation, which can be otherwise used for data processing and/or for the control of imaging devices (modalities) such as optical scanners, digital volume tomographs, computer tomographs, etc. Essential components of this computer 10 are, amongst others, a central processor 13 and an interface 11 for the receiving of scan data D of oral structures OS that were measured by a modality 1, in this case an optical scanner. Of course, CAD/CAM datasets determined by the method can be output over the interface 11 to a milling unit 20 connected to the data bus 3, with which, for example, tooth restorations may be created.

In the embodiment shown in FIG. 17, the modality 1 is connected to a control unit 2, which in turn is connected with a data bus 3 to which the tooth restoration determination system 5 is also connected. Furthermore, a mass storage device 4 for interim storage or permanent storage of scan data D recorded by the modality 1 and/or scan data D processed by the tooth restoration determination system 5 is also connected to the data bus 3. Of course, any number of components such as further modalities, mass storage devices, workstations, output devices such as printers, filming stations, milling units 20 or similar can be connected to the data bus 3 forming a larger network. Equally, a connection to an external network or further tooth restoration determination systems is possible. All scan data D are preferably formatted in the so-called STL standard (STL=Surface Tessellation Language) and/or in the DICOM standard (DICOM=Digital Imaging and Communication in Medicine).

Control of the modality 1 is performed in the usual manner via the control unit 2, which also acquires the data from the modality 1. For on-site control, the control unit 2 can comprise an own console or similar (not shown here). It is also possible for control to be performed for example via the data bus, using a separate computer located in the vicinity of the modality.

A possible sequence of the method according to the invention will be explained in the following with the aid of FIG. 1, whereby FIG. 17 is to be consulted as regards the setup of the tooth restoration determination system. In this case, the method comprises method steps Ito VI, whereby an iteration step S comprises method steps II to V. In the following, it is assumed that a determination of optimal tooth models is performed collectively for a group of tooth types, even though, according to the invention, an optimal tooth model could be determined separately for each tooth type.

Initially, in a first process step I, the scan data D are selected and the extent of the tooth types to be used by the method is determined. The scan data D can for example be forwarded from the modality 1 or its control unit 2 directly to the computer 10 via the data bus 3. The scan data D can also have been recorded previously at some time and stored in a mass storage device 4. Optionally, an interactive processing of the scan data D can be performed by the user, in which the user labels structures in the scan data that assist the individualization of the tooth models M. In particular, preparation lines LP, segmentation lines LS, anatomical landmarks AL, contact points and labels of individual teeth can be determined, interactively or with algorithmic assistance. FIG. 4 shows a schematic two-dimensional representation of scan data D with antagonist data, labeled preparation lines LP, labeled segmentation lines LS, and labeled anatomical landmarks AL.

The extent of the tooth models M to be used by the process is preferably determined by specifying a set of different tooth types. For better clarity for the user, this specification can be done using a graphical user interface and a dental notation system, an example of which is shown in FIG. 15. FIG. 3 shows the corresponding mean tooth models M of the tooth types 18-48. Preferably, the range of the tooth types to be used should correspond to the range of the tooth types of the scanned teeth. After determining the desired tooth types, it is advantageous to display the dental notation system to the user in a reduced form (e.g. as shown in FIG. 16). In the following, it is assumed that the user has selected several tooth types. In this case it is expedient to apply the variant of the method according to the invention in which groups of tooth models M are individualized.

Additionally, the linking structure of the model database DB (as shown in FIG. 2) used and/or a linear sorting P of the tooth models of the model database DB (as shown in FIGS. 13 and 14) can be forwarded for selection to a selection unit and, with the aid of a selection signal, desired tooth models M are selected that are then used by the method. In this way, the user can select desired sub-groups of tooth models M of a tooth type, for example in order to add to the method tooth models M that have particular morphological properties. This approach can be advantageous particularly for the computation of tooth restorations in the incisor region. The procedures of the first method step are performed with the aid of a selection unit 14, which is realized here in the form of a software module on the processor 13 of the computer 10.

FIG. 2 shows a very simplified schematic representation of a model database DB with linked tooth models M for two tooth types 15, 16. The circles represent tooth models M to which geometrical transformations have optionally been assigned. The tooth types and the selection indices for the corresponding model class are shown in the circles, also referred to as the nodes of the model database DB. For the sake of clarity, only a small number of tooth models M is shown, and the linking L (as a network for tooth type 15, as a hierarchy for tooth type 16) has been kept very simple.

In the exemplary embodiment described above, determination of the optimal tooth models for the desired tooth types is performed by a process comprising several iteration steps S in which, commencing with start tooth models of the desired tooth types, a group of tooth models is tested with regard to a quality criterion in each iteration step. Each iteration step therefore comprises several process steps II, III, IV, V, which are carried out in a process loop S. This optimization process is carried out in the optimization unit 15 of the tooth restoration determination system 5, which in this case is realised in the form of a software module on the processor 13 of the computer 10.

Before the first cycle of the loop S, the start tooth models for the desired tooth types are determined and positioned in the scan data. Preferably, the start tooth models are determined in the model database and are, particularly preferably, the mean tooth models of the desired tooth types. Alternatively, start models of desired tooth types can also be determined from a geometrical analysis of the scan data. One possibility is the automatic or manual measurement of teeth and/or remaining tooth structure in the scan data, in order to subsequently select, from the model database, start tooth models with geometric measurements that are as similar as possible. Typical geometric measurements are tooth width, tooth depth, distances between cusps, and incisor edge thickness, for example. After selection of the start tooth models, these should be approximately positioned relative to the scan data prior to the first loop cycle, i.e. a pre-positioning of the start tooth models is carried out. In the case of radiological scan data (e.g. DVT scan data), directional terms (anterior, posterior, etc.) of the data set are usually known, and the recorded volume usually comprises the oral cavity with adjacent structures. A similar situation applies in the case of optical jaw scans. Here also, direction conventions for the scan data are generally complied with. The occlusal surfaces of the teeth face in one defined axial direction, and the parabolic dental arches open in a further defined axial direction. The situation is slightly different in the case of intra-oral optical scans. Here also, the occlusal surfaces of the teeth face in one defined axial direction, and directional terms (e.g. mesial, distal) are known for the ends of the measured portions of a dental arch. Owing to this implicit direction information and the known dimensions of the scan data, the start tooth models can be positioned at the beginning relative to the scan data.

The loop S commences with process step II, in which the tooth model group currently in test, and at least one further group of tooth models, are loaded from a model database with the aid of a loading unit 16, realized in this case in the form of a software module on the processor 13 of the computer 10. To this end, the computer 10 comprises a memory 12 with a model database DB. FIG. 2 shows a possible linking L of tooth models M for tooth types 15 and 16 of a model database DB.

In process step III, tooth model groups are adjusted to the scan data by varying model parameters. This individualization process takes place in the individualization unit 17, which is realized here in the form of a software module on the processor 13 of the computer 10. Preferably, the individualization of tooth models is done by solving an optimization problem, in which the optimization value results from a number of optimization partial values that correspond to desired optimization criteria. After being computed, the individual optimization partial values are combined to give a single optimization value. This is preferably done by computing a weighted sum of the optimization partial values. In this way, the weightings can control the influence of each individualization criterion. For example, a large weighting factor for adjusting the tooth model to the opposing dentition in combination with a small weighting factor for adjustment to the adjacent teeth can lead to optimal tooth models that are well-adjusted to the opposing dentition, but that do not exhibit a perfect contact situation to the adjacent teeth. Preferably, the weighting factors are chosen so that all optimization criteria can be complied with equally well. The solution of the generally non-linear optimization problem can be done using methods that are known to the skilled person. A straightforward possibility is to determine the minimal optimization value using gradient descent.

One important optimization partial value describes the adjustment of a tooth model to the corresponding tooth structure and/or remaining tooth structure in the scan data. This target structure is preferably defined by preparation lines and/or segmentation lines ascertained in the scan data. The automatic and/or interactive methods of ascertaining the boundary lines are known to the skilled person. Optionally, tooth structure and/or remaining tooth structure can be labeled directly by the user. Computation of the optimization partial value is preferably performed by computing the sum of squares of the distances between tooth model vertices and the target structure. The minimum distances from the tooth model vertices to the target structure can be used as distance values, as can the distances along the surface normals of the tooth model vertices to the target structure.

A further important optimization partial value defines, in the embodiment described above, the contact of a tooth model to the opposing dentition. The opposing dentition is measured directly or indirectly using a bite registration. In both cases, so-called antagonist data are obtained. To describe the contact situation of a tooth model to a corresponding antagonist, the use of prefixed distances is suggested. A negative prefix is given for a distance value of a tooth model vertex when it lies within the antagonist, otherwise it is given a positive prefix. If the minimum distance value is now determined, a single prefixed contact distance value is obtained for a tooth model. If this value if positive, no intersection is present; a value of zero indicates one or more contact points; a negative value indicates an intersection. The optimization partial value is then preferably the square of the contact distance value. Optionally, the user can also interactively determine desired contact points and/or surfaces to the antagonists. The distances of the corresponding scan elements to the tooth model are then also used in computation of the optimization partial value. An optimization partial value for the contact of the tooth models to each other and/or to adjacent dentition can be computed in a completely analogous manner to the computation method suggested for describing contact to the opposing dentition.

Computation of an optimization partial value for adjusting a tooth model to preparation lines and/or segmentation lines can also be done by using prefixed distance values. To this end, distances of the boundary line vertices to the tooth model are preferably ascertained. A negative prefix indicates that a vertex lies within a tooth model, while a positive prefix indicates that a vertex lies outside. The boundary line distance value is preferably defined as the maximum of the positive distances, and this is squared in order to obtain the corresponding optimization partial value.

A further optimization partial value describes the adjustment of a tooth model to anatomical landmarks in the scan data. Determination of these landmarks can be done automatically and/or interactively, as will be known to the skilled person. To compute the optimization partial value, in a preferred embodiment the distances of the anatomical landmarks in the scan data to the corresponding landmarks of the tooth model are computed. The optimization partial value then results from the sum of the squares of these distances.

A simple and robust computation of an optimization partial value for the mechanical stability of a tooth restoration belonging to a tooth model is also possible using the principle of prefixed distance values. To this end, the scan data and the preparation lines belonging to a tooth model are used to construct an auxiliary object that defines the minimum material thickness for the tooth restoration. An intersection of the tooth model with this minimum object should be avoided. In other words, the optimization partial value is null in the case of a positive contact distance value of a tooth model to the corresponding minimal object, otherwise it is the square of the contact distance value.

In addition to the exemplary functional optimization partial values described above, an aesthetic optimization partial value can also be determined for a tooth model, preferably for an incisor tooth model. To compute this value, a desired shape (rectangular, triangular, square, shovel-shaped, etc.) can be specified for the tooth model, preferably automatically and/or interactively, and an optimization partial value is computed that describes the deviation of the tooth model from the desired shape. A preferred manner of computation for the discrepancy lies in determining the contour of the tooth model in a lingual-oral direction, and then adjusting this contour by translation, rotation and scaling to the desired shape. Subsequently, for the contour points of the preferred shape, the minimum distances to the adjusted contour of the tooth model are determined. The optimization partial value to be computed is then preferably the sum of the squares of these distance values.

A linking of tooth models is preferably taken into account by optimization partial values that describe the spatial relationships of the positions and/or shapes of the linked tooth models. The optimization partial value for the spatial relationships of the positions can be computed from spatial relationships of anatomical landmarks of linked tooth models. The determination of suitable landmarks preferably takes place during building of a model database and can be done interactively and/or algorithmically. A suggested computation method for the optimization partial value is based on the premise that anatomical landmarks of linked tooth models should lie on parameterized three-dimensional curves. Preferably, the sum of the squares of the distances from the landmarks to the curve is determined as optimization value. For example, the incisor edges and the cusps of upper teeth should lie on a Curve of Spee. The relative interrelationships of the shapes of the tooth models are just as important for the linking of tooth models. It is suggested that at least parts of a model database are built on the basis of a representative set of proband scan data. Tooth models of the other tooth types, originating from the same proband, correspond in that case to a tooth model of a tooth type. The optimization partial value for the linking of tooth model shapes preferably results from a computation of the differences of correspondences of the tooth models. To this end, for each tooth model to be individualized, corresponding tooth models are first identified in the model database whose tooth types are contained in the linkage group. A computation then takes place of morphological difference values of the identified corresponding tooth models to the appropriate individualized tooth models. The computation of a morphological difference value can be done in a simple and robust manner by summing the squares of the distances of vertices of two tooth models being compared, after both tooth models have been aligned as well as possible by translation and rotation. The difference value determined in this manner is referred to in the following as a correspondence deviation value. The optimization partial value for linking the shapes of the tooth models is then given by the sum of the squares of the correspondence deviation values among all of the tooth models to be individualized.

In process step IV, the computation of quality values for individualized groups of tooth model group is carried out within a quality determination unit 18, realized here in the form of a software module on the processor 13 of the computer 10. A quality value of 100% should be used for the individualization of a tooth model group for which all optimization criteria are fully complied with. Smaller percentage values describe an individualization for which individual optimization criteria are only partially fulfilled, or not at all. Preferably, the quality value is determined by converting the optimization value of the corresponding group of tooth models. The minimum possible optimization value in this case corresponds to a quality value of 100%, and the maximum possible optimization value corresponds to a quality value of 0%.

At the end of loop S, in process step V, it is determined, on the basis of the computed quality values, whether a new group to be tested of tooth models of the desired tooth types should be selected from the model database for the next iteration step S, or whether the iteration should be interrupted. This depends on whether a predefined quality criterion has been reached. Such a quality criterion can be, for example, that the quality value of the tooth model group currently being tested has exceeded a threshold value, or that a predefined number of iteration steps has been reached.

If a further iteration step is to follow, a new group to be tested of tooth models can be identified by a quality value that is better than the quality value of the current tooth model group in test. To this end, the quality values of tooth model groups can be computed one after the other, whereby the groups are obtained by varying the current group in test such that at least one tooth model of the current group in test is replaced by a tooth model that is linked to it, until a better quality value has been found. If a better quality value is not found, or if the quality value of the current tooth model group in test is satisfactory, the iteration S is also interrupted. In this respect, the fact that a further tooth model or a further tooth model group with a better quality value cannot be found may also be regarded as having fulfilled a quality criterion for interrupting the iteration.

In the final process step VI, at least one tooth restoration R is determined from the optimal tooth models M and scan data D, using standard methods known to the skilled person. In principle, the preparation lines of the scan data D are joined to the optimal tooth models in a suitable manner, as continuously and smoothly as possible, and the cavities are subsequently added as lower boundaries. The end result is three-dimensional models of milling objects for the tooth restorations R that can be manufactured by machining. A tooth restoration R can also be constructed in a segmented manner by first determining a supporting structure and then an upper construction with the occlusal surfaces. A precision adjustment of the optimal tooth models M relative to each other and/or to the scan data D can be carried out to increase the precision of the tooth restorations R to be determined, prior to their construction. It is advantageous to apply locally bounded deformation transformations on the optimal tooth models M, which perform a precision adjustment of the tooth models relative to each other and also relative to the teeth, remaining tooth structure, preparation lines, segmentation lines, bite registrations, contact points etc., using displacement values that are as small as possible and that do not generate any edges or folds. Computations of process step VI take place within a restoration unit 19, realized here in the form of a software module on the processor 13 of the computer 10. FIG. 5 is a schematic representation of exemplary scan data D with optimal tooth models M for typical inlay, crown and bridge preparations. FIG. 6 shows the corresponding tooth restorations R.

The manufacture or selection of at least one tooth restoration part is then carried out, based on the determined tooth restorations.

One embodiment of a method according to the invention of building at least parts of a model database is characterized by carrying out an analysis of a representative set of scan data D of defect-free upper and lower jaws. The use of plaster jaw impressions is suggested, since these are economical and can be precisely scanned optically. FIG. 7 shows scan data D generated in this manner. For the analysis of the shape variations of the individual teeth, it is advantageous to segment the scan data D in a first step of database building, whereby this segmentation can preferably be carried out interactively with the aid of a graphical user interface. The result of the segmentation of jaw scan data D is a set of tooth scan data sets for each tooth type (in this case: tooth number), which can be used to build at least a part of a model database.

The construction of tooth models M of a tooth type takes place in a second step of database building. Depending on the desired spatial resolution, a tooth model M is constructed for each tooth scan data set. To this end, a tooth model M can first be constructed, which consists of a triangulated surface in the form of a cuboid, with the dimensions of the tooth scan data set, whereby the triangulation delivers a desired resolution by successive subdivision of the side faces of the cuboid. An adjustment of the initially constructed tooth model M to the tooth scan data set takes place subsequently, for example by minimizing the sum of the squares of the distance values of the tooth model vertices to the tooth surface in the tooth scan data set. FIG. 8 shows tooth models M of a tooth type, that have been constructed in this manner.

Subsequently, in a third step of database building, an analysis of the morphological differences among the tooth models M of a tooth type is carried out by computing a difference value for each possible pair of tooth models M. To this end, both tooth models M of a pair are preferably aligned by an optimal translation and rotation such that the sum of the squares of the difference values of the tooth model vertices is minimized. For the distance value of a tooth model vertex of the first tooth model M of the pair, the minimum distance of the vertex to the surface of the second tooth model M of the pair can be used. The mean distance value of the tooth model vertices remaining after the adjustment can be used as the morphological difference value for the tooth model pair. A visualization of the results is preferably done by a two-dimensional array of the tooth models M as shown in FIG. 9. This array is defined in that the distances of the tooth models M to each other, up to a common scaling factor, correspond as far as possible to the corresponding difference values of the tooth models M.

In a fourth and fifth database building step, a linking of the tooth models of a model class takes place. To this end, clusters of morphologically similar tooth models M are constructed, whereby, according to the invention, the construction rule is based on morphological difference values among the tooth models M. Construction preferably comprises defining a threshold for the difference values of the tooth models M, and linking those tooth models M whose difference values lie below this threshold. A cluster is then a coherent set of interlinked morphologically similar tooth models M. FIGS. 10 and 11 show examples for a set of tooth models M with one cluster C₁ (cf. FIG. 10) or four clusters C₁, C₂, C₃, C₄ (cf. FIG. 11). An approximate guideline for the threshold is preferably derived from the requirement that the range of the largest cluster should be about half of the total number of tooth models M in the model class. Subsequently, determination of cluster mean tooth models M takes place by ascertaining for each cluster the tooth model M with the minimum sum of squares of difference values to the other tooth models M of the cluster. The cluster mean tooth model M with the minimum difference to all existing tooth models M of the model class—again defined by the sum of squares of the difference values—is of particular importance. This tooth model M will then be regarded as the mean tooth model M of the model class. For the tooth models M to be completely cohesively linked, linkings of mean tooth models to all cluster mean tooth models M are finally added.

In a final sixth database building step, geometrical transformations are added to the tooth models, preferably defined in that the shape of a tooth model can be continually transformed to all tooth models linked to it and in the same cluster. This is preferably achieved by constructing a parameterized transformation for each tooth model. The first step involves subdivision of the bounding box of a tooth model in axis-parallel cells of the same size. Displacement vectors of the cell nodes then define a tri-linear transformation of the tooth model vertices. This approach is explained in detail in the thesis “Individualisierung von digitalen anatomischen Modellen durch Computertomographie” (Tank M., 2002, Institut für Rechtsmedizin der Universität Heidelberg), and is also referred to therein as a cell method. The result is a transformation, in which the transformation parameters are arranged hierarchically according to their weight. The transformation parameters for a linking of two tooth models result from the requirements that the sum of the squares of the distance values of the transformed tooth models must be minimal to the linked tooth model, and that local surface properties should be retained as far as possible. A linear combination of the transformation parameters obtained in this way results in morphologically reasonable variations of a tooth model, since only those linked tooth models that originate from the same cluster and are therefore morphologically similar are used as transformation targets. The shape parameters of a tooth model then preferably comprise the linear factors defined in this way.

In addition to building at least parts of a model database on the basis of scan data of natural oral structures, scan data of artificial oral structures can also be used. The building method for such a model database corresponds to the building method for natural oral structures, and is performed in a completely analogous manner. The first and/or last step of database building can be dispensed with. The first step of database building, i.e. the segmentation of the scan data, is usually not necessary, since the artificial oral structures (for example artificial teeth such as prosthetic teeth or dental blanks) are physically separate and can be scanned separately. The last step of database building can also be dispensed with, in the case of the optional requirement that no geometric transformations be applied to the tooth models.

Particularly for the interactive selection of tooth models M, a linear sorting P of the tooth models M of a model class on the basis of morphological similarities is advantageous. To build a sorting, the sorting can commence with the mean tooth model M and further tooth models M of the model class can be added iteratively. The most recently added tooth model M is then referred to as the current tooth model M. The sorting criterion can be defined to always add the tooth model M that has the smallest difference value to the current tooth model M and lies in the corresponding cluster. If all tooth models M of a cluster are added, the procedure is continued for the cluster whose cluster mean tooth model M has the smallest difference value to the current tooth model M. FIG. 12 shows a sorting path P obtained in this way for a model class. FIGS. 13 and 14 show two clearer renditions of the sorting P. In FIG. 13, the tooth models are shown in a one-dimensional array, and the user can select one or more tooth models M from the sorting P, for example with mouse input of a graphical user interface. In the more compact two-dimensional illustration of FIG. 14, the sorting P is shown broken down into rows, preferably defined according to cluster C₁, C₂, C₃, C₄. Here also, the user can select one or more tooth models M with mouse input of a graphical user interface.

It shall be emphasized here again that the system architectures and processes shown in the diagrams are only exemplary embodiments that can be modified as required by the skilled person. In particular, the control unit, insofar as it is equipped with a suitable console, can also comprise all relevant components of the computer in order to carry out the processing of the measurement data directly using the method according to the invention. In this case, it follows that the control unit itself acts as the tooth restoration determination system according to the invention, and a further or separate workstation or computer is not necessary. Furthermore, it is also not absolutely necessary that the various components of tooth restoration determination system according to the invention be realized on one processor or in one computer, but can be distributed over several processors or networked computers. For the sake of completeness, it shall be pointed out that the use of the indefinite article “a” or “an” does not exclude a plurality. Equally, the terms “apparatus”, “facility”, “unit”, “module” etc. do not exclude that these may comprises several components, which also may be distributed in any manner.

Furthermore, it is possible to upgrade existing tooth restoration determination systems that implement known post-processing procedures with a process control unit according to the invention, so that such systems can also be used for the method according to the invention as described above. In many cases, it may suffice to update the control software with suitable control software modules.

1. Method of determining virtual tooth restorations on the basis of scan data (D) of oral structures, wherein
a model database (DB) comprising a number of parameterized tooth models for each of several tooth types is used, whereby the parameterization is carried out on the basis of model parameters comprising position parameters and/or shape parameters and whereby each tooth model (M) is linked with a number of tooth models (M) of the same tooth type,
for each desired tooth type, an optimal tooth model (M) in the model database (DB) is determined by means of an iterative method in which initially at least one start tooth model (M) of the desired tooth type is selected from the model database (DB), and subsequently, commencing with this start tooth model (M), in each iteration step (S) a tooth model (M) is tested with regard to a quality value, wherein
for individualization, the tooth model (M) currently in test is adjusted to the scan data (D) by varying model parameters and a quality value is computed for this individualization,
at least one tooth model (M) linked with the tooth model (M) in test is also, for individualization, adjusted to the scan data (D) by variation of model parameters and a further quality value is computed for this individualization,
on the basis of the computed quality values, a new tooth model (M) in test of the desired tooth type is selected if necessary from the model database (DB) for the next iteration step (S),
iteration is interrupted upon reaching a quality criterion,
and finally at least one virtual tooth restoration is determined from among the optimal tooth models (M) and scan data (D).

2. Method according to claim 1, characterized in that, for each desired tooth type of a tooth type group, an optimal tooth model (M) in the model database (DB) is determined by an iterative method in which initially, for each desired tooth type, at least one start tooth model (M) is selected from the model database (DB) and then, commencing with these start tooth models (M), a group of tooth models (M) is tested in each iteration step (S) with regard to a (group) quality value,
wherein
the tooth model (M) group currently in test is adjusted for individualization to the scan data (D) by variation of model parameters and a quality value is computed,
at least one further group of tooth models (M) is also adjusted for individualization to the scan data (D) by variation of model parameters, and a further quality value is computed, whereby, to form the further group, at least one tooth model (M) of the group currently in test is replaced by a tooth model (M) that is linked to it,
if necessary, a new group of tooth models (M) of the desired tooth types is selected for the next iteration step (S) from the model database (DB), on the basis of the computed quality values,
the iteration is interrupted upon reaching a quality criterion.

3. Method according to any of claims 1 to 2, characterized in that the individualization of tooth models (M) is performed by solving an optimization problem, in which an optimization value results from a number of optimization partial values, whereby at least some of the optimization partial values are chosen to describe at least one of the following optimization criteria:
the adjustment of tooth models (M) to teeth and/or remaining tooth structure,
the adjustment of tooth models (M) to opposing dentition,
the adjustment of tooth models (M) to bite registrations,
the adjustment of tooth models (M) to adjacent teeth,
the adjustment of tooth models (M) to preparation lines (LP) and/or segmentation lines (LS),
the adjustment of tooth models (M) to anatomical landmarks (AL),
the mechanical stability of virtual tooth restorations (R) belonging to tooth models (M),
the aesthetic effect of virtual tooth restorations (R) belonging to tooth models (M),
the contacts of tooth models (M),
the spatial relations of the positions of tooth models (M)
the spatial relations of the shapes of tooth models (M).

4. Method according to any of claims 1 to 3, characterized in that, after determination of the optimal tooth models (M) and prior to determining the virtual tooth restorations (R), a precision adjustment of the optimal tooth models (M) is performed relative to each other and/or to the scan data (D).

5. Method according to any of claims 1 to 4, characterized in that the search for an optimal tooth model (M) of a tooth type commences with at least one start tooth model (M), which start tooth model (M)
is defined in the model database (DB) and/or
is a mean tooth model (M) of tooth models (M) of the tooth type and/or
is determined from a geometrical analysis of the scan data.

6. Method according to any of claims 1 to 5, characterized in that the search for an optimal tooth model (M) of a tooth type commences with several start tooth models (M) of the tooth type, which start tooth models (M)
are defined in the model database (DB) and/or
are mean tooth models (M) of sub-groups of the tooth models (M) of the tooth type and/or
are determined from a geometrical analysis of the scan data.

7. Method according to any of claims 1 to 6, characterized in that the available tooth types of a model database (DB) are forwarded for selection to a selection unit, and desired tooth types are selected with the aid of a selection signal, and the method is performed on the basis of the tooth types thus selected.

8. Method according to any of claims 1 to 7, characterized in that tooth types and/or tooth models (M) of a desired tooth type, available in the model database (DB), are forwarded for selection to a selection unit, and desired tooth types and/or tooth models (M) are selected with the aid of a selection signal, and the optimal tooth models (M) are determined on this basis.

9. Method according to any of claims 1 to 8, characterized in that the shape parameters of the tooth models (M) are ordered according to their influence on the tooth model geometry and/or in that the shape parameters of the tooth models (M) parameterize three-dimensional transformation fields for the tooth models (M) and/or are geometrical construction parameters.

10. Method of manufacturing or selecting a tooth restoration part, wherein at first, on the basis of scan data (D) of oral structures, a virtual tooth restoration (R) is determined by a method according to any of claims 1 to 9, and the tooth restoration part is subsequently manufactured or chosen from a set of prefabricated tooth restoration parts, based on the determined virtual tooth restoration (R).

11. Method of generating a model database (DB) comprising a number of parameterized tooth models (M) for each of a number of different tooth types, for use in the method according to any of claims 1 to 9, whereby parameterization is performed on the basis of model parameters comprising position parameters and/or shape parameters, and whereby each tooth model (M) is linked (L) with a number of tooth models (M) of the same tooth type.

12. Method according to claim 11, characterized in that at least parts of the model database (DB) are built by the analysis of a set of scan data (D) of artificial and/or natural oral structures, in which, for a desired tooth type,
the scan data (D) are optionally segmented in order to obtain scan data (D) of the desired tooth type,
tooth models (M) of the model database (DB) are constructed by adjustment to the scan data (D) of the desired tooth type,
an analysis of morphological differences among the tooth models is carried out, wherein a difference value is computed for each possible pair of tooth models (M),
clusters (C1, C2, C3, C4) of morphologically similar tooth models (M) are formed by an analysis of difference values amongst the tooth models (M),
a linking (L) of tooth models (M) within the clusters (C1, C2, C3, C4) and of mean tooth models (M) of the clusters (C1, C2, C3, C4) is performed.

13. Method according to claim 12, characterized in that parameterized geometrical transformations are added to the tooth models (M), defined in that the shape of a tooth model (M) can be smoothly transformed to at least one tooth model (M) of the same cluster (C1, C2, C3, C4) linked to that tooth model (M).

14. A computer program product, directly loadable in the memory of a computer, comprising program code means for carrying out all steps of a method according to any of claims 1 to 13 when said computer program product is run on the computer.

15. Tooth restoration determination system (5) for determining virtual tooth restorations on the basis of scan data (D) of oral structures, comprising
an interface (11) for receiving scan data (D) measured by a measurement means,
a selection unit (14) for determining the tooth types to be used by the method,
a memory means (12) with a model database (DB) that comprises a number of parameterized tooth models (M) for each of several tooth types, wherein the parameterization is performed using model parameters comprising position parameters and/or shape parameters, and wherein each tooth model (M) is linked (L) with a number of tooth models (M) of the same tooth type,
an optimization unit (15), realised to determine an optimal tooth model (M) from the model database (DB) for each desired tooth type, using an iterative method in which, commencing with at least one start tooth model (M) a tooth model (M) is tested with regard to a quality value at each iteration step (S),
a loading unit (16), realised to load tooth models (M) from a model database (DB),
an Individualization unit (17), realised to adjust at least one tooth model (M) currently in test, and at least one tooth model (M) linked to the tooth model (M) currently in test, to the scan data (D) for individualization by varying model parameters,
a quality determination unit (18), realised to determine quality values for individualization of the tooth models (M) and to assess quality criteria for interruption of the iteration, and
a restoration unit (19), realised to determine at least one virtual tooth restoration (R) from the optimal tooth models (M) and scan data (D).
